(19) United States
(12) Patent Application Publication
(10) Pub. No.: US 2013/0168247 A1
(43) Pub. Date: Jul. 4, 2013

(54) ION ANALYZER

(71) Applicant: HORIBA, LTD., Kyoto-shi (JP)

(72) Inventor: Yasukazu Iwamoto, Kyoto-shi (JP)

(73) Assignee: HORIBA, LTD., Kyoto-shi (JP)

(21) Appl. No.: 13/727,386

(22) Filed: Dec. 26, 2012

(30) Foreign Application Priority Data
Dec. 28, 2011 (JP) 2011-287806

(51) Int. Cl. G01N 27/333

(52) U.S. Cl. CPC G01N 27/333
USPC 204/417

(57) ABSTRACT

This invention relates to an ion analyzer of a multisensor type that can conduct an accurate analysis and that is easy to maintain. The ion analyzer has a liquid membrane type ion-selective electrode comprising multiple types of ion-sensitive membranes wherein each of multiple types of ionophores that selectively capture different ion is supported by a base material respectively, an internal solution and a liquid junction from which the internal solution exudes, and the multiple types of the ion-sensitive membranes and the liquid junction are arranged on the same supporting body, and at least one ion-sensitive membrane among the multiple types of the ion-sensitive membranes is arranged outside of an area that is immersed in the internal solution that exudes from the liquid junction.

### FIELD OF THE ART

This invention relates to an ion analyzer of a multisensor type for analyzing a plurality of types of ions.

### BACKGROUND ART

A variety of ionophores (ion-selective ligands) that can selectively capture a specific ion are conventionally known. Furthermore, a liquid membrane type ion-selective electrode comprising a liquid membrane type ion-sensitive membrane wherein an ionophore is supported has been developed by making use of the ionophores (patent document 1). It is possible for this liquid membrane type ion-selective electrode to detect a variety of analyte ions by changing the ionophore according to the target ion. As a result, it is also possible to fabricate a multisensor capable of detecting multiple analyte ions by the use of the liquid membrane type ion-selective electrode.

### PRIOR ART DOCUMENT

Patent document 1 Japanese Unexamined Patent Application Publication No. 2007-33333
Patent document 2 Japanese Unexamined Patent Application Publication No. 63-138255

### DISCLOSURE OF THE INVENTION

### Problems to be Solved by the Invention

However, there are some ionophores that capture ions other than a target analyte ion because of the high affinity of the ionophore for ions. Accordingly, if the ionophore that has a high affinity for the ion contained in the internal solution of the reference electrode is supported by an ion-sensitive membrane, as shown in the patent document 2, in the case where the liquid junction of the reference electrode and the ion-sensitive membrane are arranged on the same supporting body, the ionophore supported by the ion-sensitive membrane captures the ion contained in the internal solution that exudes from the liquid junction, which might prevent the target ion from being analyzed.

Conventionally, in the case where the liquid membrane type ion-sensitive membrane is contaminated by an ion other than the analyte ion (in the case where an ion other than the analyte ion is captured by the ionophore), a so-called aging process is conducted, whereby the ion-sensitive membrane is washed by an aqueous solution containing the analyte ion, whereby the ion contaminant in the pore of the ionophore is replaced by the analyte ion. In particular, in the case where an electrolyte contained in the internal solution that exudes from the liquid junction crystallizes, a lengthy aging process is required.

Accordingly, the present claimed invention intends to provide a multisensor type ion analyzer that can conduct an analysis with high accuracy and that is easy to maintain.

### Means to Solve the Problems

More specifically, an ion analyzer in accordance with this invention has a liquid membrane type ion-selective electrode comprising multiple types of ion-sensitive membranes wherein multiple types of ionophores that selectively capture a different ion are supported by a base material respectively, an internal solution and a liquid junction from which the internal solution exudes, and is characterized in that the multiple types of the ion-sensitive membranes and the liquid junction are arranged on the same supporting body, and at least one ion-sensitive membrane among the multiple types of ion-sensitive membranes is arranged outside of an area that is immersed in the internal solution that exudes from the liquid junction.

Most of all, it is preferable that the multiple types of the ion-sensitive membranes and the liquid junction are arranged in a line, wherein among the multiple types of the ion-sensitive membranes, those with the biggest selectivity coefficients of the ionophore supported by the ion-sensitive membrane to an ion contained in the internal solution, are arranged at the furthest positions from the liquid junction. It is more preferable that relative to the liquid junction, an ion-sensitive membrane wherein the ionophore whose selectivity coefficient to the ion contained in the internal solution is smaller (lower in affinity) is supported, and an ion-sensitive membrane wherein the ionophore whose selectivity coefficient to the ion contained in the internal solution is bigger (higher in affinity) is supported, are arranged in a line in this order.

In accordance with this arrangement, it is possible to prevent the ion-sensitive membrane wherein the ionophore whose selectivity coefficient to the ion contained in the internal solution is bigger is supported from being contaminated with the ion contained in the internal solution. As a result, it is possible to conduct a highly accurate analysis, a troublesome aging process becomes unnecessary, and a cursory washing on the sensor surface by the use of water or the correction liquid will suffice even though the internal solution exudes from the liquid junction.

In order to form the liquid membrane type ion-sensitive membrane, for example, a base material resin, an elasticizer, and an ionophore are dissolved into an organic solvent, the dissolved resin, elasticizer and ionophore are poured into a predetermined frame formed on a supporting body, and the organic solvent is evaporated. However, if two of the ion-sensitive membranes spread and contact each other in a liquid state prior to evaporation of the organic solvent, it is not possible to ensure that they are insulated from each other. On the contrary, if a concave groove or a convex wall is formed to separate the multiple types of the ion-sensitive membranes, it is possible to prevent the ion-sensitive membranes from making contact with each other even though the different ion-sensitive membranes are allowed to spread. In addition, if a concave groove or a convex wall is formed at least between the multiple types of the ion-sensitive membranes, it is possible to effectively prevent the ion-sensitive membrane wherein the ionophore whose selectivity coefficient to the ion contained in the internal solution is bigger is supported from being contaminated even though the internal solution exudes from the liquid junction.

A representative example of the ion analyzer in accordance with this invention is an ion analyzer wherein the multiple types of the ionophores are a sodium ionophore and a potassium ionophore, the internal solution is an aqueous solution of ammonium salt, and the liquid junction, a sodium ion-sensitive membrane wherein the sodium ionophore is supported, and a potassium ion-sensitive membrane wherein the potassium ionophore is supported are arranged in a line in this order.

In accordance with this arrangement, even though an ammonium ion whose selectivity coefficient to a potassium ionophore such as Bis (12-crown-4) is large is contained in the internal solution, since the potassium ion-sensitive membrane is arranged at a position distant from the liquid junction, it is possible to prevent the potassium ion-sensitive membrane from being contaminated by the ammonium ion. As a result, even though the amount of the potassium ion in urine is small, it is possible to conduct the analysis with high accuracy so that the ion analyzer can be preferably used as an analyzer to measure a ratio between the sodium ion concentration and the potassium ion concentration in urine.

### Effect of the Invention

In accordance with this invention having the above arrangement, since the ion-sensitive membrane wherein an ionophore whose selectivity coefficient to the ion contained in the internal solution of the reference electrode is bigger is supported can be prevented from being contaminated, it is possible both to conduct the analysis with high accuracy and to facilitate the maintenance.

### BRIEF DESCRIPTION OF THE DRAWINGS

FIG. 1 is an exploded perspective view showing a structure of an ion analyzer in accordance with one embodiment of this invention.

FIG. 2 is a longitudinal cross-sectional view showing a structure of a flat-type sensor of this embodiment.

FIG. 3 is an exploded perspective view showing a principal part of the flat-type sensor of this embodiment.

FIG. 4 is an enlarged perspective view showing a principal part of a flat-type sensor in accordance with other embodiment.

### BEST MODES OF EMBODYING THE INVENTION

One embodiment of this invention will be explained with reference to drawings.

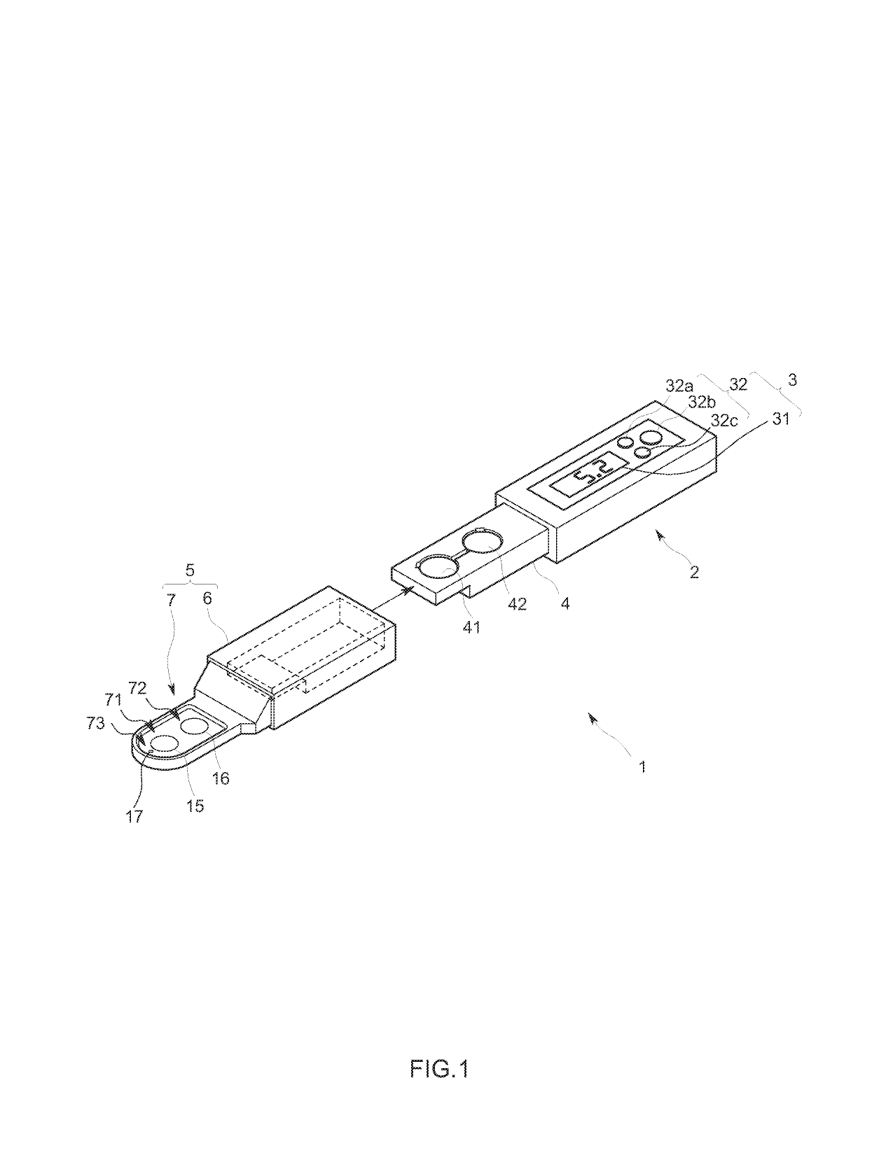

An ion analyzer 1 in accordance with this embodiment for measuring a concentration of a sodium ion and a concentration of a potassium ion in, for example, urine, and as shown in FIG. 1, comprises a body 2 made of a resin, an arithmetic processing part (not shown in drawings) such as a micro computer incorporated in the body 2, a display/operation part 3 formed on an upper surface of the body 2, a power source part 4 formed adjacent to the display/operation part 3 and an electrode part 5 made of a synthetic resin and formed in a water-proof structure.

Lead parts 21A, 22A, 23A 24A, and 25A of a flat-type sensor 7, to be described later, and a connecting part 63 that is connected to a circuit substrate 62 having the arithmetic processing part are provided inside of the body 2. The circuit substrate 62 is connected to and supported by a case.

The display/operation part 3 comprises a display part 31 and an operation part 32 that operates various buttons such as a power button 32a, a correction button 32b and a hold button 32c. The power source part 4 comprises button batteries 41 and 42.

The electrode part 5 comprises a tubular part 6 whose one end opens to make it possible to house the power source part 4 and a flat-type sensor 7 that is continuously arranged at the other end of the tubular part 6. The electrode part 5 is configured so that it can be integrally connected with the body 2 by being mounted on the body 2 so as to cover the power source part 4 or so that it can be separated from the body 2.

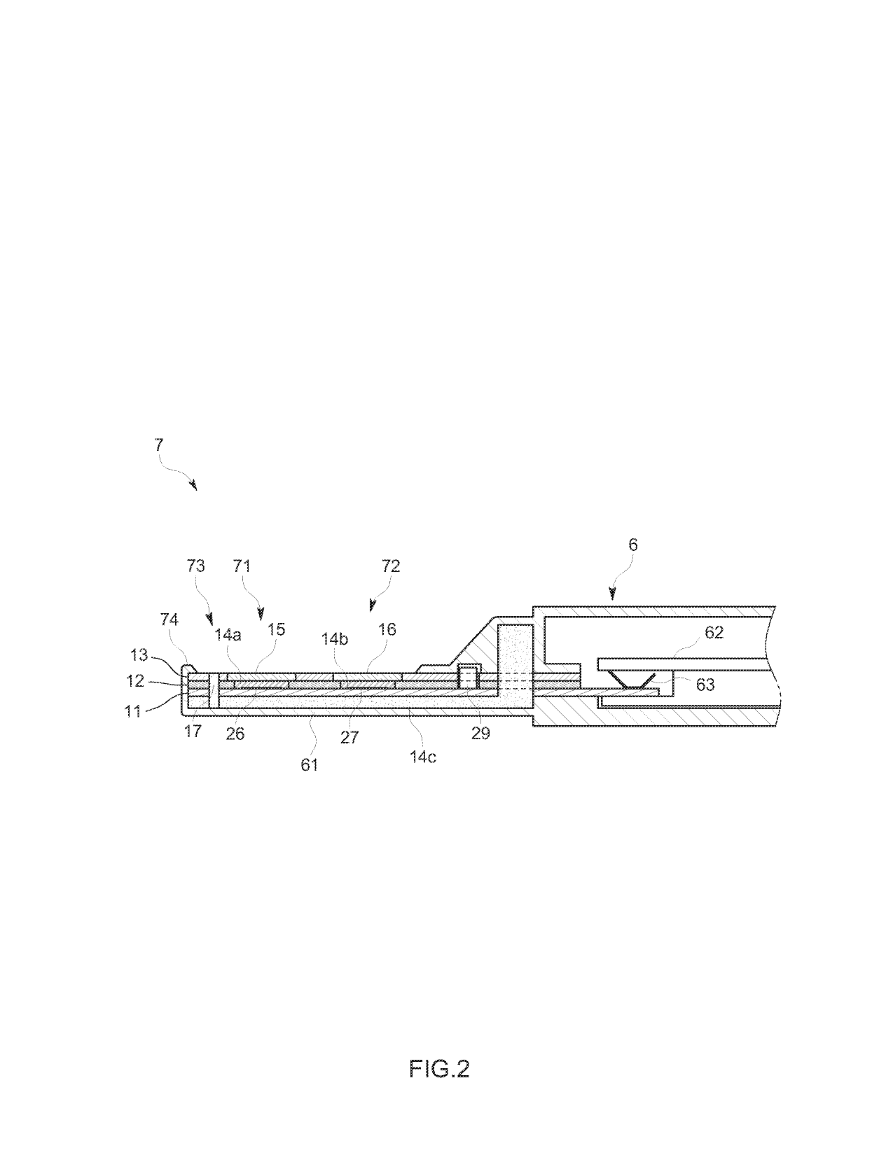

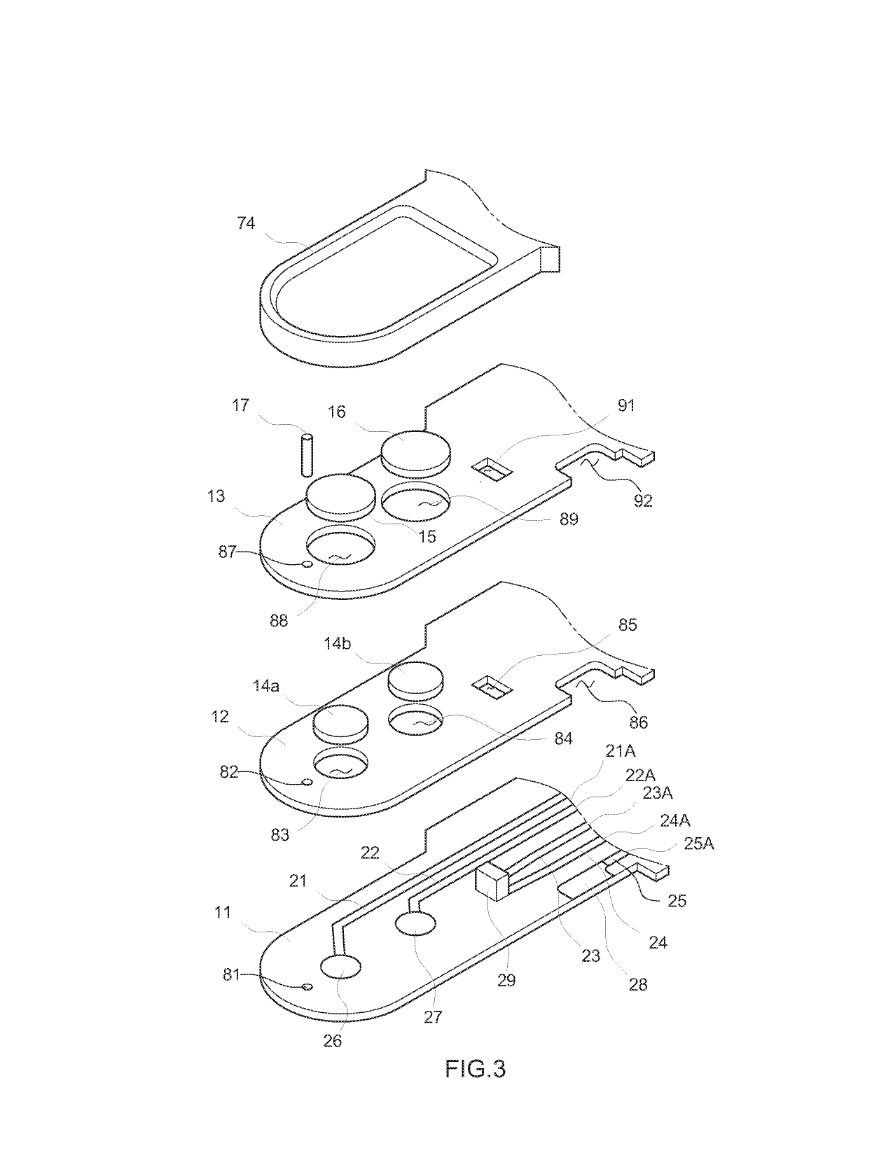

The flat-type sensor 7 is, as shown in FIG. 2 and FIG. 3, made of a material such as polyethylene terephthalate having electrical insulation, and comprises substrates 11, 12, and 13 each of which is laminated. A part of each substrate 11, 12, and 13 is formed in a shape of an arc. The third substrate 13 positioned as the top layer and the second substrate 12 positioned as the middle layer have the same shape (in a plane view), and the arc part of the first substrate 11 positioned as the lower layer is the same as that of the second substrate 12 and the third substrate 13, and other side of the first substrate 11 is longer than that of the second substrate 12 and the third substrate 13. In addition, a detector liquid holder 74 is arranged to surround a peripheral border of the third substrate 13, and a sample housing part is formed by the detector liquid holder 74.

Conductive parts 21, 22, 23, 24, and 25 are formed on an upper surface of the first substrate 11 by silk-screen printing, for example, Ag paste after providing a predetermined pretreatment, and a circular through bore 81 is formed on the first substrate 11. The conductive parts 21, 22, 23, 24, and 25 are processed as follows. First, a distal end of the conductive part 21 located at one of the outer sides is covered with AgCl and a circular inner electrode 26 of a Na⁺ electrode 71 is formed, and a distal end of the conductive part 22 located at an inner side of the conductive part 21 is also covered with AgCl and a circular inner electrode 27 of a K⁺ electrode 72 is formed. In addition, a distal end of the conductive part 25 located at the other outer side is also covered with AgCl and an inner electrode 28 of a reference electrode 73 having an elongated shape locating at one of the side end parts of the substrate 11 is formed. Furthermore, a temperature compensating element 29 such as a thermistor is arranged over a distal end of the conductive part 23 and a distal end of the conductive part 24, wherein the conductive parts 23 and 24 are located at an inner side. The other end of each conductive parts 21, 22, 23, 24, and 25 constitute lead parts 21A, 22A, 23A, 24A, and 25A respectively.

The second substrate 12 is provided with a through bore 82 that is arranged at a position corresponding to the through bore 81 and that has the same diameter as that of the through bore 81 and through bores 83 and 84, each of which is formed at a position corresponding to each of the inner electrode 26 and inner electrode 27 and whose diameters are a little larger than those of the through bores 81 and 82, and a rectangular through bore 85 that is formed at a position corresponding to the temperature compensating element 29 and whose size is generally the same as that of the temperature compensating element 29. Furthermore, an elongated cutout 86 is formed at a side end part corresponding to the inner electrode 28 of the reference electrode 73.

The third substrate 13 is provided with a through bore 87 that is arranged at a position corresponding to the through bores 81 and 82 and that has the same diameter as that of the through bores 81 and 82, through bores 88 and 89 each of which is formed at a position corresponding to each of the through bore 83 and the through bore 84 and whose diameter is a little larger than that of the through bores 83 and 84, and a rectangular through bore 91 that is formed at a position corresponding to the through bore 85 and whose size is generally the same as that of the through bore 85. Furthermore, a cutout 92 whose size is the same as that of the cutout 86 is formed at a position corresponding to the cutout 86.

A liquid junction 17 of the reference electrode 73 composed of a porous body made of polyethylene is inserted into the through bores 81, 82, and 87 each of which is formed at the corresponding position of each of the substrates 11, 12, and 13 respectively. The liquid junction 17 is mounted in a state that the upper surface of the liquid junction 17 is generally flush with an upper surface of the third substrate 13 positioned as the top layer.

A gelled internal solution 14a is mounted on the through bore 83 formed on the second substrate 12 and a gelled internal solution 14b is mounted on the through bore 84 on the second substrate 12. The gelled internal solution 14a is formed into a disk shape and made of a pH buffer solution containing CaCl₂ to which a sodium ion is added and to which a gelatinizing agent and a gel evaporation retardant are further added. The gelled internal solution 14b is formed into a disk shape and made of a pH buffer solution containing CaCl₂ to which a potassium ion is added and to which a gelatinizing agent and a gel evaporation retardant are further added. A Cl⁻ concentration of the internal solution is adjusted to 0.1M˜the saturated concentration. The gelled internal solution 14a is mounted inside of the through bore 83 in a state that an upper surface of the gelled internal solution 14a projects a little from an upper surface of the second substrate 12, and makes contact with the inner electrode 26 formed on an upper surface of the first substrate 11 through the through bore 83. The gelled internal solution 14b is mounted inside of the through bore 84 in a state that an upper surface of the gelled internal solution 14b projects a little from an upper surface of the second substrate 12, and makes contact with the inner electrode 27 formed on the upper surface of the first substrate 11 through the through bore 84.

A disk shaped sodium ion-sensitive membrane 15 is mounted on the through bore 88 formed on the third substrate 13 and the sodium ion-sensitive membrane 15 makes contact with the gelled internal solution 14a and is fixed to the third substrate 13 in a state that an upper surface of the gelled internal solution 14a is generally flush with the upper surface of the third substrate 13. A disk shaped potassium ion-sensitive membrane 16 is mounted on the through bore 89 formed on the third substrate 13 and the potassium ion-sensitive membrane 16 makes contact with the gelled internal solution 14b and is fixed to the third substrate 13 in a state that the upper surface of the gelled internal solution 14b is generally flush with the upper surface of the third substrate 13.

The solid sodium ion-sensitive membrane 15 is formed with a procedure of adding a plasticizer, and Bis (12-crown-4) as a sodium ionophore to polyvinyl chloride (PVC), dissolving the polyvinyl chloride to which the plasticizer and Bis (12-crown-4) are added with tetrahydrofuran (THF), filling the dissolved polyvinyl chloride into the through bore 88 by means of potting or an ink jet printing method, and heating so as to evaporate tetrahydrofuran (THF).

The potassium ion-sensitive membrane 16 is formed by the same method as that of the sodium ion-sensitive membrane 15 except for using Bis (benzo-15-crown-5) as a potassium ionophore.

The liquid junction 17, the sodium ion-sensitive membrane 15 and the potassium ion-sensitive membrane 16 are arranged in a line, and the potassium ion-sensitive membrane 16 wherein the potassium ionophores whose selectivity coefficient to an ammonium ion is bigger is supported is arranged at a position farther away from the liquid junction 17. The selectivity coefficient of the potassium ionophore (Bis (benzo-15-crown-5)) and the selectivity coefficient of the sodium ionophore (Bis (12-crown-4)) are as follows.

potassium ionophore selectivity coefficient:log k_{K,NH}_{₄}^{pot}=−2.1

sodium ionophore selectivity coefficient:log k_{Na,NH}_{₄}^{pot}=−3

A gelled internal solution 14c of the reference electrode 73 is arranged from below the first substrate 11 locating at the lowest layer to the upside of the third substrate 13 locating at the top layer in a case 61 continuously arranged to the tubular part 6. The gelled internal solution 14c is so filled that an upper part and a lower part of the gelled internal solution 14c are in communication through a gap between a side part, in the internal electrode 28 side of the reference electrode 73, of the substrates 11, 12, and 13 and the case 61, and the gelled internal solution 14c makes contact with a surface of the inner electrode 28 of the reference electrode 73 and the lower end part of the liquid junction 17. The gelled internal solution 14c of the reference electrode 73 is an internal solution comprising an NH₄Cl aqueous solution of concentration 0.1 M˜the saturated concentration to which a gelling agent and a gel evaporation retardant are added.

In order to measure the sodium ion concentration or the potassium ion concentration in urine using the ion analyzer 1, an adequate amount of the urine is first placed dropwise on the sodium ion-sensitive membrane 15 and the potassium ion-sensitive membrane 16. As a result, an electromotive force is generated at the sodium ion-sensitive membrane 15 in accordance with a difference between an ionic concentration of the gelled internal solution 14a and an ionic concentration of the urine and an electromotive force is generated at the potassium ion-sensitive membrane 16 in accordance with a difference between an ionic concentration of the gelled internal solution 14b and the ionic concentration of the urine. Each of the electromotive forces is detected as an electric potential difference between the internal electrode 26 of the Na⁺ electrode 71 and the internal electrode 28 of the reference electrode 73, and an electric potential difference between the internal electrode 27 of the K⁺ electrode 72 and the internal electrode 28 of the reference electrode 73 respectively. Then, the sodium ion concentration and the potassium ion concentration are calculated based on the electromotive forces, and displayed on the display part 31.

In accordance with the ion analyzer 1 of this invention having the above-mentioned arrangement, since the potassium ion-sensitive membrane 16 is arranged farther away from the liquid junction 17, the sodium ion-sensitive membrane 16 will not contact the internal solution of the reference electrode 73 even though the internal solution exudes from the liquid junction 17. As a result of this, it is possible to prevent the potassium ion-sensitive membrane 16 from being contaminated by an ammonium ion contained in the internal solution of the reference electrode 73. This makes it possible to conduct an analysis of a small amount of sodium ions in urine with high accuracy. In addition, this arrangement makes it possible to omit the aging process, since washing of the flat-type sensor 7 will suffice even though the internal solution of the reference electrode 73 exudes from the liquid junction 17.

The present claimed invention is not limited to the above-mentioned embodiment.

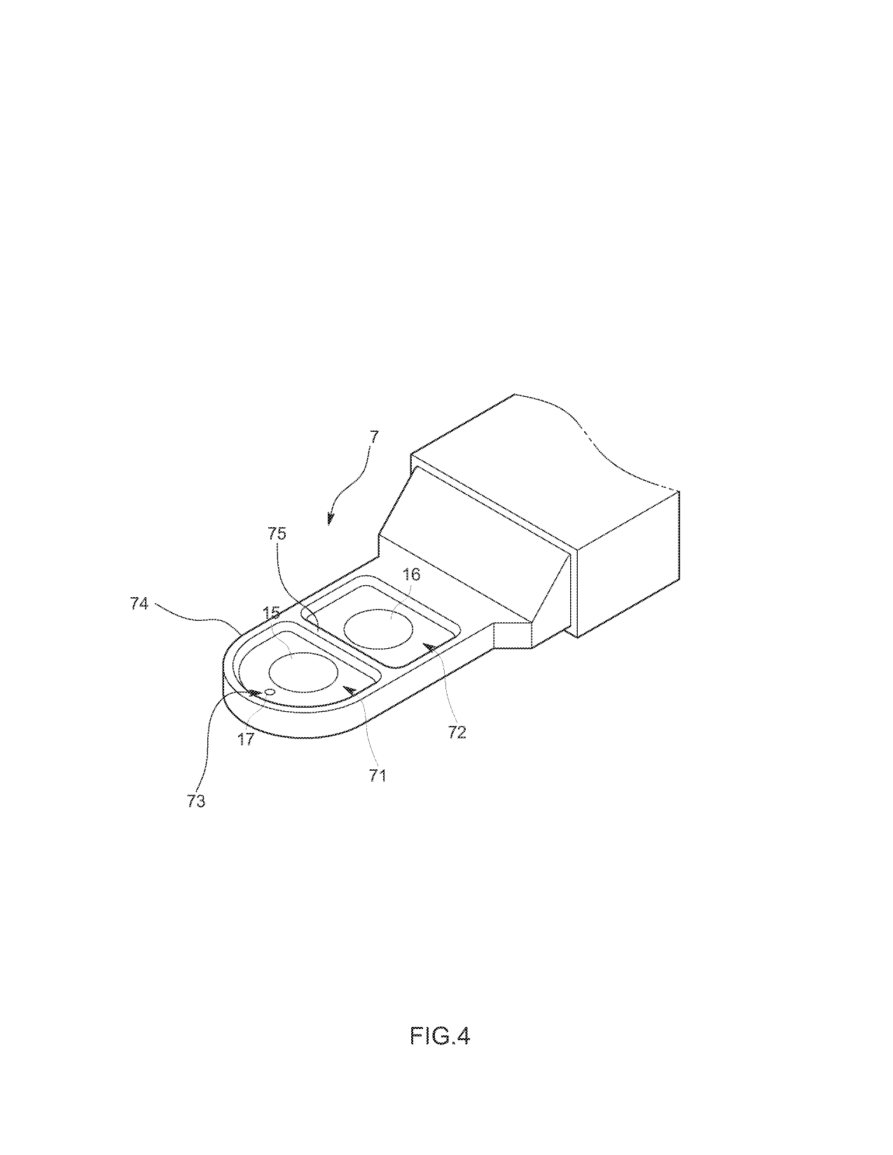

For example, in order to prevent the insulation between the sodium ion-sensitive membrane 15 and the potassium ion-sensitive membrane 16 from being damaged from the membranes contacting each other in a liquid state prior to evaporation of the organic solvent, or in order to more effectively prevent the potassium ion-sensitive membrane 16 from getting contaminated by the internal solution of the reference electrode 73, a convex wall 75 may be arranged, as shown in FIG. 4, between the sodium ion-sensitive membrane 15 and the potassium ion-sensitive membrane 16. In addition, a concave groove may be arranged instead of the convex wall 75.

In addition, an installation surface of the sodium ion-sensitive membrane 15 and the potassium ion-sensitive membrane 16 may be in a stepwise shape or inclined wherein the potassium ion-sensitive membrane 16 is arranged at a position higher than that of the sodium ion-sensitive membrane 15. Furthermore, in the case where the sodium ion-sensitive membrane 15 and the potassium ion-sensitive membrane 16 are arranged on the inclined surface, locating the sodium ion-sensitive membrane 15 and the potassium ion-sensitive membrane 16 at a position higher than that of the liquid junction 17 will suffice, irrespective of which of the sodium ion-sensitive membrane 15 and the potassium ion-sensitive membrane 16 are located at a higher or lower position.

The ion analyzer in accordance with this invention is not limited to a combination of the sodium ion-sensitive membrane and the potassium ion-sensitive membrane, and may be a sensitive membrane. If the ammonium ion-sensitive membrane and the potassium ion-sensitive membrane are combined and used, it is possible to constitute an ion analyzer that can measure an ammonium ion concentration by correcting an influence from the potassium ion. For example, TD19C6 can be used as an ammonium ionophore, and for example, Bis (benzo-15-crown-5) can be used as the potassium ionophore.

A part or all of the above-mentioned embodiment or the modified embodiment can be combined without departing from a spirit of this invention.

### EXPLANATION OF REFERENCE CHARACTERS

1 . . . ion analyzer
14c . . . gelled internal solution of the reference electrode
15 . . . sodium ion-sensitive membrane
16 . . . potassium ion-sensitive membrane
17 . . . liquid junction
71 . . . Na⁺ electrode
72 . . . K⁺ electrode
73 . . . reference electrode

1. An ion analyzer having a liquid membrane type ion-selective electrode comprising:
multiple types of ion-sensitive membranes wherein each of multiple types of ionophores that selectively captures a different ion is supported by a base material respectively, an internal solution and a liquid junction from which the internal solution exudes, wherein
the multiple types of the ion-sensitive membranes and the liquid junction are arranged on a supporting body, and
at least one ion-sensitive membrane among the multiple types of the ion-sensitive membranes is arranged outside of an area that is immersed in the internal solution that exudes from the liquid junction.

2. The ion analyzer described in claim 1, wherein
the multiple types of the ion-sensitive membranes and the liquid junction are arranged in a line, and
among the multiple types of the ion-sensitive membranes, the bigger a selectivity coefficient of the ionophore supported by the ion-sensitive membrane to an ion contained in the internal solution is, the farther a position from the liquid junction at which the ion-sensitive membrane is arranged.

3. The ion analyzer described in claim 1, wherein
a concave groove or a convex wall to separate the multiple types of the ion-sensitive membranes is formed.

4. The ion analyzer described in claim 1, wherein
the multiple types of the ionophores are a sodium ionophore and a potassium ionophore,
the internal solution is an aqueous solution of ammonium salt, and
the liquid junction, a sodium ion-sensitive membrane wherein the sodium ionophore is supported, and a potassium ion-sensitive membrane wherein the potassium ionophore is supported are arranged in a line in this order.
